(19) United States
(12) Patent Application Publication
(10) Pub. No.: US 2013/0047941 A1
(43) Pub. Date: Feb. 28, 2013

(54) CONTROL DEVICE FOR INTERNAL COMBUSTION ENGINE

(71) Applicants: Yuusuke NIWA, Anjo-city (JP); Ryo SANO, Kariya-city (JP)

(72) Inventors: Yuusuke NIWA, Anjo-city (JP); Ryo SANO, Kariya-city (JP)

(73) Assignee: DENSO CORPORATION, Kariya-city (JP)

(21) Appl. No.: 13/590,507

(22) Filed: Aug. 21, 2012

(30) Foreign Application Priority Data
Aug. 26, 2011 (JP) 2011-184312

(51) Int. Cl. F01L 9/04; F02D 41/00

(52) U.S. Cl. 123/90.11

(57) ABSTRACT

A control device for an engine variably controls electricity power supplied to a motor driving a valve to open or close a fluid passage based on operation condition of the engine. The valve has a full close range in which the fluid passage is closed. When the engine has low load and low rotation, the control device stops supplying the electricity power to the motor, and the valve is held at a neutral position where a biasing force of a first biasing portion and a biasing force of a second biasing portion are balanced. The neutral position is set within the full close range.

### CROSS REFERENCE TO RELATED APPLICATION

This application is based on Japanese Patent Application No. 2011-184312 filed on Aug. 26, 2011, the disclosure of which is incorporated herein by reference in its entirety.

### TECHNICAL FIELD

The present disclosure relates to a control device for an internal combustion engine.

### BACKGROUND

JP-A-2007-285123 (JP-B-4661668, US 2007/0240676) or JPA-2010-242972 describes an exhaust gas recirculation (EGR) control system. As shown in FIG. 12, an EGR control system has a valve 101 with a full close position O and a full open position C. Further, the valve 101 is defined to have a control point A for full-close between the full close position O and the full open position C. When the valve 101 is controlled to be fully closed, electricity supply to a motor driving the valve 101 is continued in a manner that the valve 101 is stopped at the control point A.

A driving force of the motor driving the valve 101 through a shaft 106 and a biasing force of a return spring biasing the valve 101 are balanced with each other at the control point A (neutral position). The valve 101 has a control range defined between the control point A for full-close and the full close position C.

As shown in FIGS. 13A and 13B, the valve 101 is arranged in a nozzle 103, and a C-shaped seal ring 110 is fitted with a groove 109 of the valve 101. The valve 101 has a dead band with an angle of α° in which a leak amount of EGR gas is not changed around the full close position O, and the control point A for full-close is set in the dead band.

However, because it is necessary to continue energizing the motor so as to hold the valve 101 at the neutral position, the consumption electric power is increased and the fuel efficiency becomes low.

### SUMMARY

It is an object of the present disclosure to provide a control device for an internal combustion engine that can reduce the consumption power and improve the fuel efficiency.

According to an example of the present disclosure, a control device for an internal combustion engine includes, a fluid control valve, a motor, a plurality of gears, a first biasing portion, a second biasing portion and a controller. The fluid control valve defines a fluid passage communicating with a combustion chamber of the internal combustion engine and has a valve that opens or closes the fluid passage. The motor drives the valve in an open direction or a close direction. The plurality of gears transmits a power of the motor to the valve. The first biasing portion biases the valve in the close direction, and the second biasing portion biases the valve in the open direction. The controller variably controls electricity power supplied to the motor based on operation condition of the internal combustion engine. The fluid control valve has a full close range in which the fluid passage is closed when the valve is operated to be fully closed. The valve is held at a neutral position where a biasing force of the first biasing portion and a biasing force of the second biasing portion are balanced with each other when the controller stops supplying the electricity power to the motor. The neutral position is set within the full close range. The controller stops supplying the electricity power to the motor when the internal combustion engine has low load and low rotation.

Accordingly, the consumption power can be reduced and the fuel efficiency can be improved.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating a control system controlling an engine according to an embodiment;

FIG. 2 is a cross-sectional view illustrating a flow rate control valve device of the control system;

FIG. 3 is a plan view illustrating a gear-receiving concave portion of a housing of the flow rate control valve device;

FIG. 4A is a schematic view illustrating an open degree of the flow rate control valve device when the engine is stopped, and FIG. 4B is a cross-sectional view illustrating the flow rate control valve device when the engine is stopped;

FIG. 5A is a schematic view illustrating an open degree of the flow rate control valve device when the engine is idling, and FIG. 5B is a cross-sectional view illustrating the flow rate control valve device when the engine is idling;

FIG. 6A is a schematic view illustrating an open degree of the flow rate control valve device when the engine has low to middle load, and FIG. 6B is a cross-sectional view illustrating the flow rate control valve device when the engine has low to middle load;

FIG. 7A is a schematic view illustrating an open degree of the flow rate control valve device when the engine has high load, and FIG. 7B is a cross-sectional view illustrating the flow rate control valve device when the engine has high load;

FIG. 8 is a timing chart illustrating a control in the open degree of the flow rate control valve device;

FIG. 9 is a cross-sectional view illustrating a flow rate control valve device of a comparison example;

FIG. 10 is an enlarged view of FIG. 9;

FIG. 11A is a plan view illustrating gears of the comparison example, and FIG. 11B is an enlarged view of FIG. 11A illustrating a backlash between two of the gears;

FIG. 12 is a cross-sectional view illustrating a flow rate control valve device of a conventional art; and

FIG. 13A is an explanatory view illustrating a full close position of the flow rate control valve device of the conventional art, and FIG. 13B is an explanatory view illustrating a flow rate dead band of the flow rate control valve device of the conventional art.

### DETAILED DESCRIPTION

### Embodiment

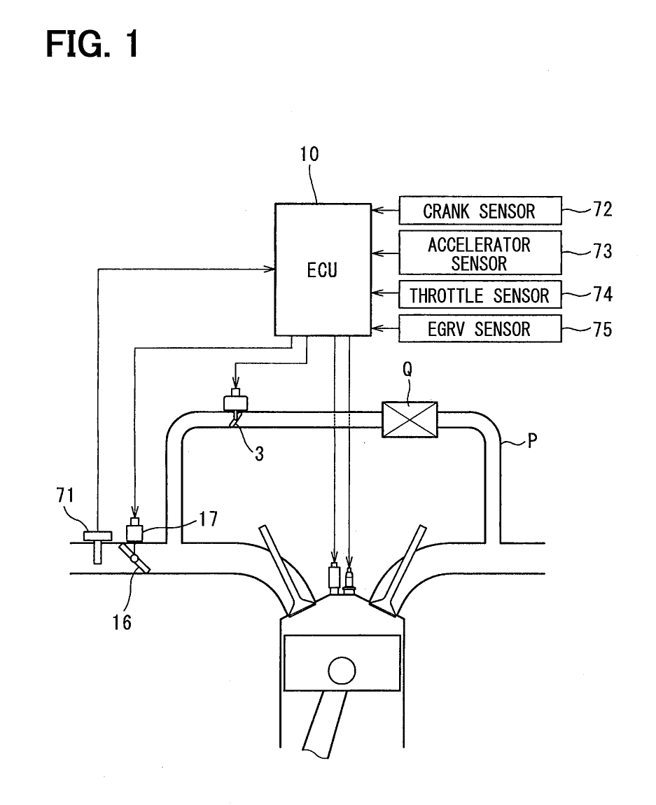

A configuration of an engine control system according to an embodiment will be described with reference to FIGS. 1, 2 and 3.

The engine control system shown by FIG. 1 corresponds to a control device for an internal combustion engine, and includes an electronic throttle device and an exhaust gas recirculation (EGR) device. The electronic throttle device controls a flow rate of intake air supplied to the combustion engine. The EGR device recirculates EGR gas, which is a part of exhaust gas exhausted from the engine, to the engine. In addition to the EGR device and the electronic throttle device, the engine may include a supercharging device having a turbocharger which superchargingly compresses intake air using exhaust pressure of the exhaust gas.

The engine is arranged in an engine compartment of a vehicle such as a car together with the EGR device. The engine is a multi-cylinder gasoline engine having plural cylinders (cylinder bores). Alternatively, the present disclosure may be applied to a direct-injection type multi-cylinder diesel engine.

The engine has an intake duct, an exhaust duct and an EGR duct P. The intake duct defines an intake passage through which intake air is drawn into a combustion chamber of each cylinder of the engine. The exhaust duct defines an exhaust passage through which the exhaust gas is discharged from the combustion chamber. The EGR duct P defines an EGR passage through which the EGR gas flows from the exhaust passage to the intake passage.

An air cleaner, the electronic throttle device, a surge tank, and an intake manifold (not shown) are installed in the intake duct. A gathering part of the intake manifold is connected to the surge tank. An outlet part of each branch pipe of the intake manifold is connected to an intake port of each cylinder of the engine. The intake duct has an EGR gas unification part at which the EGR gas introduced from the exhaust passage joins to new and fresh outside air filtered with the air cleaner.

An exhaust manifold, an exhaust cleaning device (catalyst), and a muffler (not shown) are installed in the exhaust duct. An outlet part of each branch pipe of the exhaust manifold is connected to an exhaust port of each cylinder of the engine. A gathering part of the exhaust manifold is connected to the exhaust cleaning device through an exhaust pipe. The exhaust duct has an EGR gas branch part at which the EGR gas is branched into the EGR device.

The EGR device has the EGR duct P, an EGR cooler Q at which the EGR gas is cooled by exchanging heat with cooling water, and an EGR gas flow rate control valve device (EGRV) controlling a flow rate of the EGR gas. An EGR valve 3 of the EGRV is a butterfly valve, and an actuator opens or closes the EGR valve 3 by driving to rotate a rotation shaft 6 of the EGR valve 3, as shown in FIG.

2. The EGR device further has a spring SP biasing the EGR valve 3 in a valve closing direction or a valve opening direction, and an electronic control unit 10 (ECU) controlling electricity supplied to a motor M which is a drive source of the actuator.

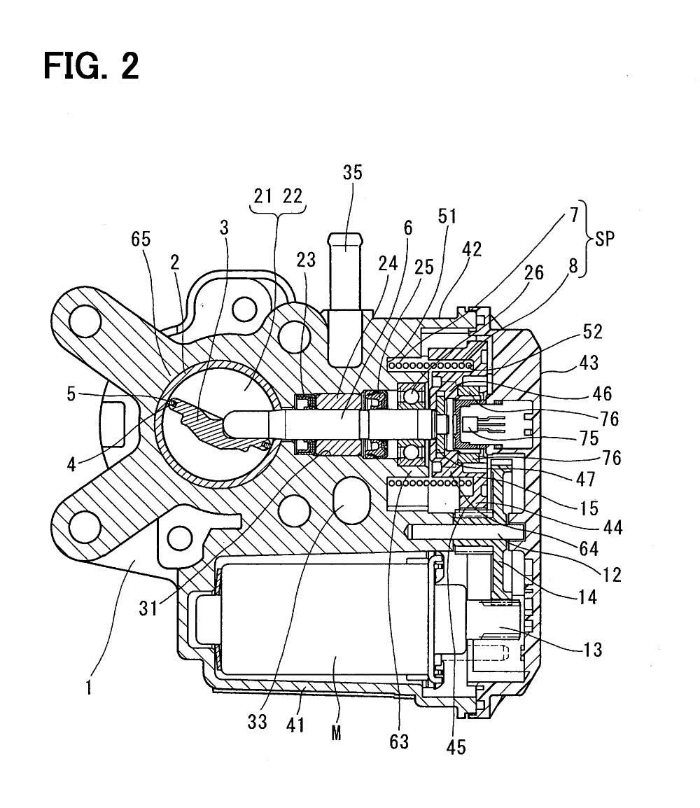

The EGRV controls an EGR rate representing a ratio of the EGR gas amount to the total amount of intake air supplied to the combustion chamber of each cylinder of the engine. As shown in FIG. 2, the EGRV has a housing 1, a nozzle 2, the EGR valve 3, a seal ring 5 and the rotation shaft 6. The housing 1 is coupled with a middle of the EGR duct P. The nozzle 2 protects the housing 1 from heat of EGR gas. The EGR valve 3 is rotatably accommodated in the nozzle 2. The seal ring 5 is fitted with a seal ring groove (annular groove) 4 defined around the periphery of the EGR valve 3. The rotation shaft 6 supports and fixes the EGR valve 3.

The spring SP has a return spring 7, an overturn spring 8 and a U-shape hook 9. The return spring 7 biases the EGR valve 3 in the valve closing direction. The overturn spring 8 biases the EGR valve 3 in the valve opening direction. The U-shape hook 9 is formed by bending a combine part at which the return spring 7 and the overturn spring 8 are combined with each other to have a reversed-U-shape.

The actuator has the motor M, a deceleration mechanism and a rotation angle detecting device. The motor M generates a drive force driving the EGR valve 3 when electric power is supplied to the motor M. The deceleration mechanism slows down rotation of the electric motor M to be transmitted to the shaft 6 of the EGR valve 3. The rotation angle detecting device detects a rotation angle of the shaft 6 of the EGR valve 3.

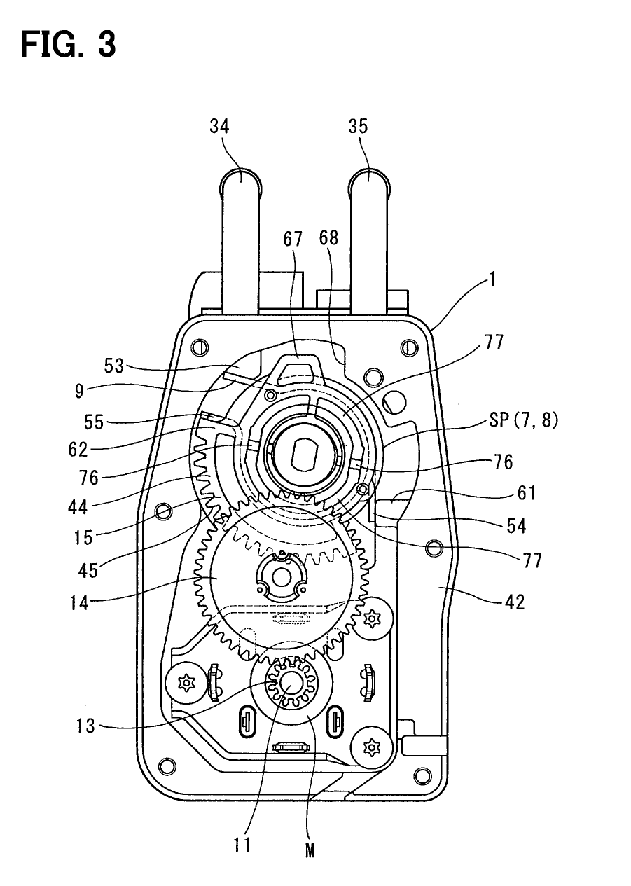

As shown in FIGS. 2 and 3, the deceleration mechanism has a pinion gear 13, a middle gear 14 and an output gear 15, which are rotated by interlocking with a motor output shaft 11 of the electric motor M. Further, the deceleration mechanism has a middle gear shaft 12 (support shaft) arranged in parallel with the motor shaft 11. The pinion gear 13 may be referred as motor gear or a first gear. The middle gear 14 may be referred as a second gear. The output gear 15 may be referred as a valve gear, a third gear or a last gear.

The cylinder block and the cylinder head of the engine has an intake port which is opened/closed by an intake valve and an exhaust port which is opened/closed by an exhaust valve. An injector and a spark plug are attached inside of each cylinder head of the engine. The injector injects fuel into the combustion chamber, and the spark plug ignites the air-fuel mixture in the combustion chamber. Moreover, the combustion chamber (cylinder bore) is defined inside of each engine cylinder (cylinder block). A piston connected through a connecting rod to a crankshaft is slidably supported to reciprocate in each cylinder bore. The air cleaner has a filter element filtering outside air (intake air). An outlet end of the air cleaner is connected to a throttle body of the electronic throttle device through the intake duct which defines the intake passage through which the intake air passes after flowing through the air cleaner.

The electronic throttle device has the throttle body, a throttle valve 16, and an actuator. The cylindrical throttle body defines the intake passage. The throttle valve 16 is rotatably accommodated inside the throttle body (throttle bore). The actuator rotates a shaft of the throttle valve 16 to open or close the intake passage. The electronic throttle device corresponds to an air flow rate control device controlling the flow rate of intake air by opening/closing the throttle valve 16.

The actuator has an electric motor 17, a deceleration mechanism, and a rotation angle detecting device. The motor 17 generates power driving the throttle valve 16 when the motor 17 receives supply of electric power. The deceleration mechanism slows down rotation of the electric motor 17 to be transmitted to the shaft of the throttle valve 16. The rotation angle detecting device detects a rotation angle of the shaft of the throttle valve 16. The electric motor 17 is electrically connected to a battery mounted in the vehicle through a motor driving circuit which is electronically controlled by the ECU 10.

When the EGR valve 3 is opened, the exhaust gas is returned to the intake passage as the EGR gas via the EGR duct P. The EGR duct P defines an EGR passage 21, 22, as shown in FIG. 2, through which the EGR gas is returned from the exhaust passage (EGR gas branch part) to the intake passage (EGR gas unification part). The EGR passage 21, 22 is defined inside of the EGR duct P which communicates with the combustion chamber of each cylinder of the engine.

The EGRV controls the flow rate of the EGR gas flowing back from the exhaust passage to the intake passage through the EGR passage 21, 22 by opening/closing the EGR valve 3, that is by changing the open area of the EGR passage 21, 22.

The housing 1 of the EGRV is made of heat-resistant metal, and is connected to the EGR duct P on the upstream or downstream side using a fastener such as bolt. Specifically, the housing 1 may be connected to the EGR gas branch part of the exhaust duct or the EGR gas unification part of the intake duct. The housing 1 holds the EGR valve 3 through the shaft 6 rotatably in a rotation direction in a range between a fully closed position and a fully opened position.

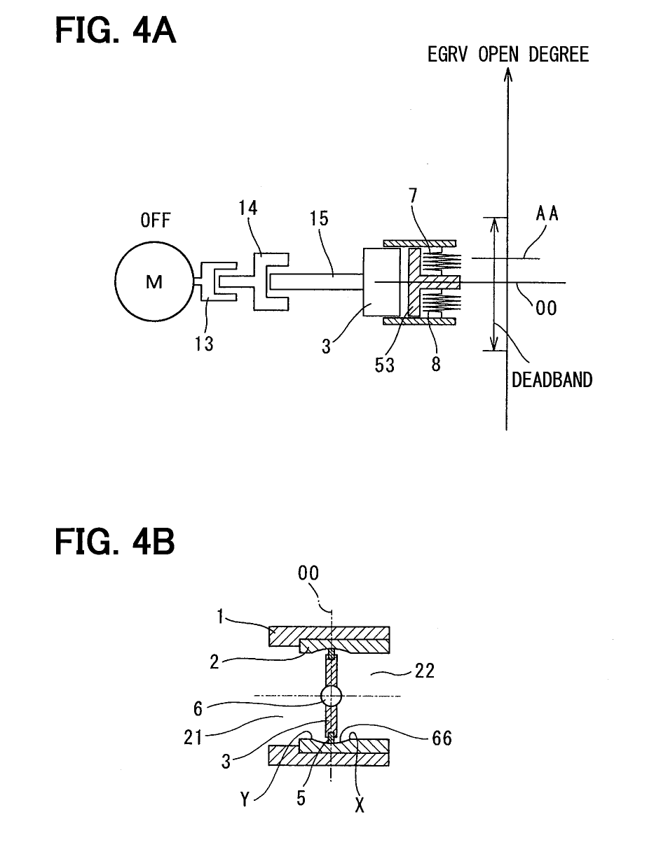

The EGR passage 21 is defined in the housing 1 to communicate with the combustion chamber of each cylinder of the engine, and the EGR passage 22 is defined in the nozzle 2 to communicate with the combustion chamber of each cylinder of the engine (see FIG. 4B, for example). The EGR gas is recirculated from the EGR gas branch part of the exhaust duct to the EGR gas unification part of the intake duct through the EGR passage 21, 22 (fluid passage, internal passage of the housing 1). The EGR passage 21 is located upstream (or downstream) of the EGR passage 22 in the flowing direction of EGR gas. The housing 1 has a cylindrical bearing holder that surrounds a bearing portion (constructed by a dust seal 23, a bushing 24, an oil seal 25, and a ball bearing 26) in a circumference direction, which supports the shaft 6 to slide in the rotation direction.

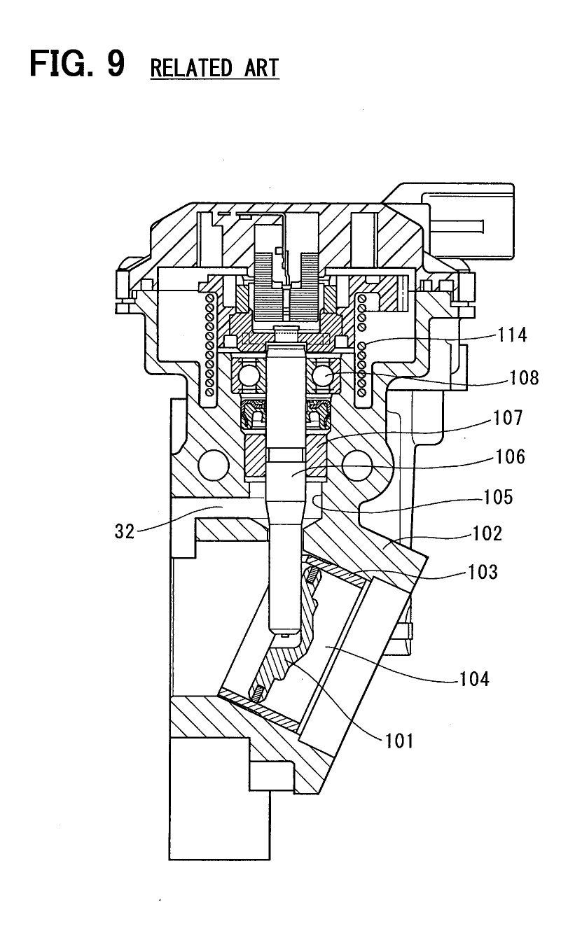

As shown in FIG. 2, a bearing hole 31 is defined inside of the bearing holder, and extends in an axis direction of the shaft 6. In addition, a communication hole 32 (refer to FIG. 9) may be further defined inside of the bearing holder to remove impurity (combustion remnants and particles such as carbon) contained in the exhaust gas from the bearing hole 31. The impurity is returned to the EGR passage (or the intake passage) downstream of the EGR valve 3 in the flowing direction of EGR gas using a negative pressure of intake air. In this case, the dust seal 23 can be abolished.

As shown in FIG. 3, two coolant pipes 34, 35 are connected to the housing 1. The housing 1 has a coolant passage 33 defined around, for example, the bearing hole 31 and the bearing portion. Coolant of the engine is introduced into the coolant passage 33 through the coolant pipe 34, 35.

The EGR valve 3 has a disc shape made of heat-resistant metal, and is fixed to an end of the shaft 6 in the axis direction by welding. The sectional shape of the EGR passage 21, 22 may be made to correspond to the outer shape of the EGR valve 3.

The circular seal ring groove 4 is defined in the peripheral end surface of the EGR valve 3, and continuously extends in the circumference direction. The seal ring 5 having a ring shape or C-shape made of heat-resistant metal is inserted into the seal ring groove 4.

The shaft 6 of the EGRV is made of heat-resistant metal, and is rotatably and slidably accommodated inside of the bearing hole 31 of the housing 1. The shaft 6 is a valve shaft or a revolving shaft of the EGRV, and is driven to rotate by power of the actuator (torque of the electric motor M).

The shaft 6 has an axis portion extending inside of the bearing hole 31 of the housing 1 in the axis direction. The axis portion of the shaft 6 is inserted to extend in the bearing hole 31 of the housing 1. The shaft 6 has a first projection portion and a second projection portion between which the axis portion is located in the axis direction. The first projection part is projected into the EGR passage 21, 22 from an open end of the bearing portion of the housing 1. The EGR valve 3 is fixed to the first protrusion portion by welding. The second projection portion is projected into a gear space accommodating the gears 13, 14, 15 from an open end of the bearing portion of the housing 1.

The actuator is used as a valve drive unit which opens/closes the EGR valve 3. The actuator has the electric motor M driving the EGR valve 3 in the valve opening direction or the valve closing direction, the deceleration mechanism (power transmission device) transmitting the rotations of the electric motor M by slowing down by two steps, the rotation angle detecting device detecting the valve open degree of the EGRV, and an actuator case accommodating the components of the actuator.

The actuator case has a motor housing 41, a gear housing 42 and a sensor cover 43. The motor housing 41 has a concave portion accommodating the electric motor M. The gear housing 42 has a concave portion accommodating the deceleration mechanism. The gear space accommodating the gears 13, 14, 15 is defined between the concave portion of the gear housing 42 and the sensor cover 43. The sensor cover 43 closes the open side of the concave portion of the gear housing 42. The motor housing 41 and the gear housing 42 are integrated with the outer wall of the housing 1. The sensor cover 43 is made of synthetic resin excellent in the insulation property.

The electric motor M is accommodated in the concave portion of the motor housing 41. The pinion gear 13 is fixed by pressing into the outer periphery of the motor shaft 11 of the motor M. The middle gear 14 is rotated by being engaged with the pinion gear 13, and the output gear 15 is rotated by being engaged with the middle gear 14. The three gears 13, 14, 15 are rotatably accommodated in the concave portion of the gear housing 42.

The middle gear 14 is rotatably fitted with the outer periphery of the shaft 12. Plural large-diameter teeth meshing with the pinion gear 13 and plural small-diameter teeth meshing with the output gear 15 are defined on the periphery of the middle gear 14.

The output gear 15 is integrally molded with synthetic resin. A circular teeth part 44 is integrally defined on the periphery of the output gear 15. Plural output gear teeth 45 are defined on the periphery of the teeth part 44 and meshes with the teeth of the middle gear 14. The output gear teeth 45 are defined in an area having a fan shape with a predetermined angle.

A rotor 46 made of synthetic resin is integrated with the inner circumference part of the output gear 15. A metal valve gear plate 47 is insert-molded inside of the rotor 46. Thereby, the output gear 15 is fixed to the second projection portion of the shaft 6 through the valve gear plate 47, with the rotation-stopped state.

The spring SP has a first coil (corresponding to the return spring 7) and a second coil (corresponding to the overturn spring 8). The first coil and the second coil are spirally wound between a bottom face (spring seat part) of a ring recess 51 of the gear housing 42 and a bottom face (spring seat part) of a ring recess 52 of the output gear 15, which is an external wall surface of the housing 1.

The first coil is the return spring 7 (first biasing portion) which generates a biasing force (spring load, spring force) biasing the EGR valve 3 in the valve closing direction relative to the output gear 15. The return spring 7 biases the EGR valve 3 to return the EGR valve 3 from a fully opened position to a neutral position.

The second coil is the overturn spring (second biasing portion) 8 which generates a biasing force (spring load, spring force) biasing the EGR valve 3 in the valve opening direction relative to the output gear 15. The overturn spring 8 biases the EGR valve 3 to return the EGR valve 3 from a position passing through the neutral position to the neutral position.

The spring SP is made of a single coil spring produced by connecting a right end part of the return spring 7 to a left end part of the overturn spring 8 at a combine part by involving a left end part of the return spring 7 and a right end part of the overturn spring 8 in different directions. An end of the return spring 7 in the axis direction, which opposes the housing, has an annular first coil end part in contact with the spring seat part of the gear housing 42. The other end of the overturn spring 8 in the axis direction, which opposes the output gear, has an annular second coil end part in contact with the spring seat part of the output gear 15.

The combine part at which the return spring 7 and the overturn spring 8 are connected with each other has the U-shape hook 9 that is held by a block-shaped opener stopper 53 integrally formed with the gear housing 42 when the engine is stopped or when supply of the electric power to the electric motor M is suspended. The spring SP has a first hook portion 54 projected from the terminal part of the first coil in the tangential direction, and a second hook portion 55 extending from the terminal part of the second coil outward in the radial direction. The first hook portion 54 is held by a first locking part 61 defined in the gear housing 42. The second hook portion 55 is held by a second locking part 62 defined in the output gear 15.

Next, details of the housing 1, the nozzle 2, the EGR valve 3, and the output gear 15 are explained.

The housing 1 has the block-shaped first locking part 61 which locks the first hook portion 54 of the return spring 7. The output gear 15 has the block-shaped second locking part 62 which locks the second hook portion 55 of the overturn spring 8. The housing 1 has the bearing holder holding the bearing portion such as the dust seal 23, the bushing 24, the oil seal 25, and the ball bearing 26. The bearing holder has a cylindrical first boss part (block) 63 having the bearing hole 31 inside. The first boss part 63 is formed to project into the space accommodating the gears from the bottom face of the gear housing 42 corresponding to the external wall surface of the housing 1.

The first boss part 63 supports the shaft 6 of the EGR valve 3, in rotatable state, through the bearing portion (the ball bearing 26). An outside diameter of the first boss part 63 is set to be smaller than an inside diameter of the return spring 7. The outer peripheral part of the first boss part 61 works as a guide which guides the inner circumference of the return spring 7.

The valve gear plate 47 is insert-molded to the rotor 46 of the output gear 15, and has a through hole having a structure which prevents a skid of the shaft 6. The output gear 15 has the cylindrical second boss part (block) 64 inside of which the rotor 46 is integrated. The second boss part 64 is formed to project from the inner circumference part of the teeth part 44 toward the housing. An outside diameter of the second boss part 64 is set to be smaller than an inside diameter of the overturn spring 8. The outer peripheral part of the second boss part 64 works as a guide which guides the inner circumference of the overturn spring 8.

The housing 1 has a cylindrical nozzle fitting 65 surrounding the circumference of the cylindrical nozzle 2 in the circumference direction. The cylindrical nozzle fitting 65 holds by fitting with the periphery of the nozzle 2. The nozzle 2 is fixed by press-fitting with the inner circumference of the fitting 65 of the housing 1. In addition, the EGR passages 21, 22 are defined inside of the housing 1 and the nozzle 2, respectively. The EGR passage 21, 22 causes the EGR gas to flow from the EGR gas branch part of the exhaust duct to the EGR gas unification part of the intake duct, and communicates with the combustion chamber of each cylinder of the engine.

The inner circumference surface of the nozzle 2, which slidably contacts the seal ring 5, has a sphere-surface concave portion 66. The sphere-surface concave portion 66 is constructed by a part of surface of a sphere which has a curvature radius centering on the rotation axis of the EGR valve 3.

A full close side stopper part 67 is arranged in the outer peripheral part of the output gear 15. The full close side stopper part 67 is mechanically engaged with a block-shaped full close side stopper 68 integrally formed in the gear housing 42, when the EGR valve 3 rotates in the valve closing direction across a full close side limit position. The full close side stopper 68 is used as a first regulation part which regulates the rotation range of the movable component (the shaft 6 and the output gear 15) such as the EGR valve 3 in the valve closing direction. Thereby, when the full close side stopper part 67 of the output gear 15 contacts the full close side stopper 68, the movable component of the EGR valve 3 is restricted from rotating in the valve closing direction.

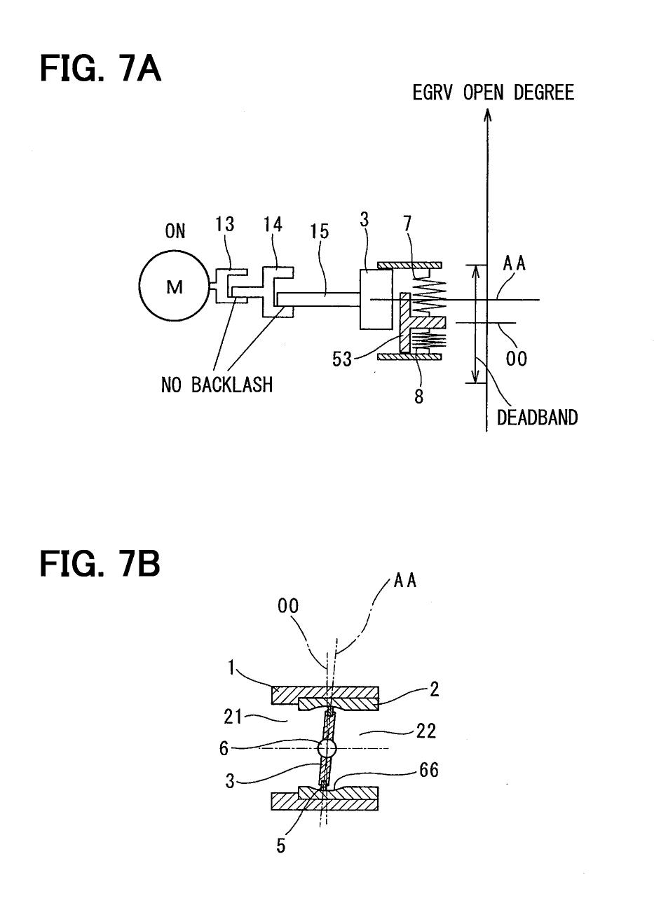

In the embodiment, as shown in FIGS. 4A and 4B, the open degree of the valve 3 is defined as zero)(θ=0°) when the valve 3 is located at a mechanical opener position OO (neutral position). Further, as shown in FIGS. 7A and 7B, when the valve 3 is located at a full close position AA, the open degree of the valve 3 at the maximum full close position regulated by the full close side stopper 68 may be set to have an angle of −17° (θ=−17°) relative to the neutral position. That is, the maximum full close position is located at a valve position slightly displaced in the valve closing direction from the mechanical opener position OO by a minute angle such as −17°. The full close position AA is defined for the controlling.

A full open side stopper part (not shown) is arranged in the outer peripheral part of the output gear 15. The full open side stopper part is mechanically engaged with a block-shaped full open side stopper (not shown) integrally formed in the gear housing 42, when the EGR valve 3 rotates in the valve opening direction across a full open side limit position. The full open side stopper is used as a second regulation part which regulates the rotation range of the movable component (the shaft 6 and the output gear 15) such as the EGR valve 3 in the valve opening direction. Thereby, when the full open side stopper part of the output gear 15 contacts the full open side stopper, the movable component of the EGR valve 3 is restricted from rotating in the valve opening direction.

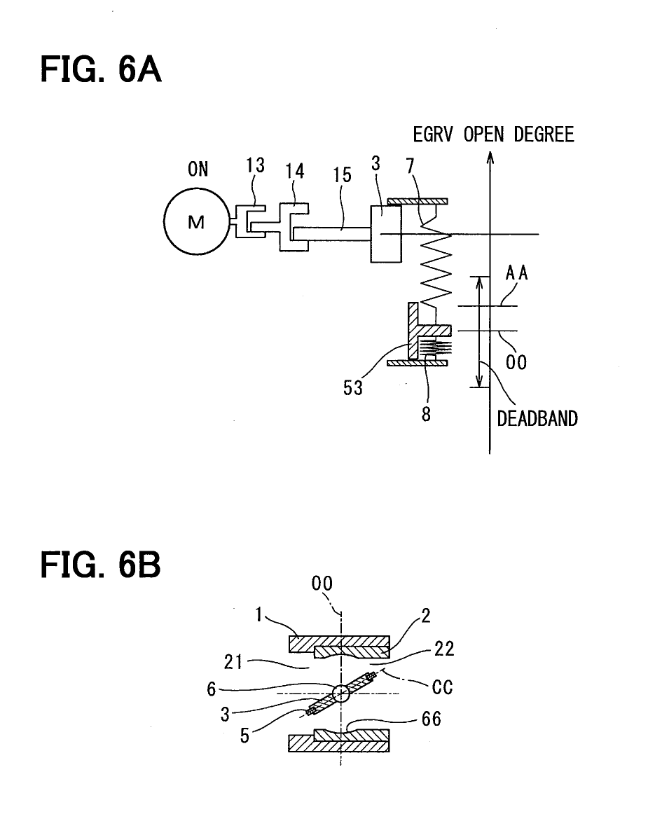

In the embodiment, as shown in FIGS. 6A and 6B, when the valve 3 is located at a full open position CC, the open degree of the valve 3 at the maximum full open position regulated by the full open side stopper may be set to have an angle of +70° (θ=+70°) relative to the neutral position. That is, the maximum full open position is located at a valve position displaced in the valve opening direction from the mechanical opener position OO by a predetermined angle such as +60-90°.

The EGR valve 3 is operated to rotate in a movable range from the mechanical opener position OO or from the full close position AA to the full open position CC, thereby controlling the EGR rate by changing the open area of the EGR passage 21, 22. Here, the full close position AA may be defined only for controlling and may be different from a true (real) full close position. The seal ring groove 4, to which the seal ring 5 is fitted, is formed in all the circumference of the peripheral end face of the EGR valve 3.

The inner circumference of the seal ring 5 is fitted and held by the seal ring groove 4 to be able to move in the groove 4 in the radial direction, the axis direction and the circumference direction, in a state where the outer circumference of the seal ring 5 is projected outward in the radial direction from the peripheral end face of the EGR valve 3.

Therefore, the EGRV tightly closes and seals a clearance defined between the inner circumference of the nozzle 2 (valve seat surface of the sphere-surface concave portion 66) and the outer circumference of the EGR valve 3, using tension of the seal ring 5 in the radial direction (diameter-extended direction) which intersects perpendicularly to the axis direction, when the engine is stopped or when the EGR gas is not introduced (at EGR-cut time).

Here, the EGRV of this embodiment has a passage full close range in which the EGR passage 21, 22 is gas-tightly closed when the EGR valve 3 is operated to be fully closed. Moreover, the EGRV has a flow rate dead band in which the leak amount of EGR gas does not change when the EGR valve 3 is operated to open or close. The passage full close range may be a range of the flow rate dead band, and may correspond to a formation section of the sphere-surface concave portion 66.

Here, the EGRV of this embodiment has the actuator which opens/closes the EGR valve 3 by rotating the shaft 6. The motor M is a drive source of the actuator and is electrically connected to the battery mounted in the vehicle through the motor driving circuit which is electronically controlled by the ECU 10.

The motor driving circuit variably controls the electric power supplied to the motor M based on a signal output from the microcomputer of the ECU 10. The signal may be a duty ratio of PWM signal. The electric power supplied to the motor M may be indicated by a current driving the motor or a voltage applied to the motor.

Here, the energizing control of the actuator (the electric motor M) is conducted by the ECU 10. The ECU 10 has a well-known microcomputer including a central processing unit (CPU), a read only memory (ROM), a random access memory (RAM), an input circuit, an output circuit, a power circuit and a timer circuit. The ECU 10 receives signals from an air flow meter 71, a crank angle sensor 72, an accelerator opening sensor 73, a throttle opening sensor 74, an EGRV opening sensor 75, a coolant temperature sensor, and an exhaust gas sensor such as an air-fuel ratio sensor or oxygen concentration sensor after A/D conversion.

The microcomputer measures and calculates the amount of new air flowing through the intake duct of the engine based on an AFM signal output from the air flow meter 71 and a throttle opening signal output from the throttle opening sensor 74. The computed amount of new air is used for various engine control (for example, used for controlling the open degree of the EGR valve 3: EGRV opening control).

The microcomputer measures and calculates the amount of EGR gas flowing back to the intake duct based on an EGRV opening signal output from the EGRV opening sensor 75. The computed amount of EGR gas is used for various engine control (for example, used for controlling the open degree of the throttle valve 16: throttle opening control).

The microcomputer determines a target value of the EGRV opening in accordance with operation condition of the engine (for example, intake air quantity measured from the AFM signal of the air flow meter 71, engine rotation velocity measured from the NE pulse signal of the crank sensor 72, or engine load signal of the accelerator sensor 73 or the throttle opening sensor 74). Further, the microcomputer conducts a feedback control by performing a proportional-integral-derivative (PID) control relative to the duty ratio of PWM signal input into the motor driving circuit which drives the electric motor M, so as to reduce a deviation between of the EGRV opening measured from the EGRV opening signal of the EGRV opening sensor 75 and the target value.

The air flow meter 71 is an air amount detector detecting the amount of new air drawn into the combustion chamber of each cylinder of the engine.

The crank angle sensor 72 is a rotation angle detector detecting a rotation angle of a crankshaft of the engine. The crank angle sensor 72 is comprised of a pickup coil converting the rotation angle of the crankshaft of the engine into an electrical signal and outputs the NE pulse signal every crank angle (CA) of 30°.

The ECU 10 works as a rotation speed detector detecting the engine rotation speed NE by measuring an interval time of the NE pulse signals output from the crank angle sensor 72.

The accelerator opening sensor 73 is an engine load detector detecting the pedaling amount of an accelerator as an accelerator opening.

The rotation angle detecting device is used as the throttle opening sensor (engine load detector) 74 detecting the throttle opening corresponding to the rotation angle of the shaft of the throttle valve 16 by measuring the rotation angle of a magnet rotor. The magnet rotor is coupled with the throttle valve 16 to have rotation integrally with throttle valve 16.

The rotation angle detecting device is used as the EGRV opening sensor (valve position detector) 75 detecting the EGRV opening corresponding to the rotation angle of the shaft 6 of the EGR valve 3 by measuring the rotation angle of a magnet rotor. The magnet rotor is coupled with the EGR valve 3 to have rotation integrally with EGR valve 3. Specifically, the magnet rotor is fixed to the inner circumference part of the output gear 15 that is fixed to the second projection part of the shaft 6 of the EGR valve 3 by insert-molding.

The magnet rotor has a pair of magnets 76 and a yoke 77. The pair of magnets 76 generates a magnetic flux to the EGRV opening sensor 75. The yoke concentrates the magnetic flux (magnetic field) emitted from the magnet 76 to the EGRV opening sensor 75.

The EGRV opening sensor 75 has a semiconductor Hall device which is a non-contact type magnetism sensing element detecting the magnetic flux which is varied in accordance with the movement of the magnet rotor (the pair of magnets 76 and the yoke 77) in the rotation direction. The semiconductor Hall device has a magnetism-sensing surface sensing the amount, the density and the strength of the magnetic field applied from the magnet rotor.

The EGRV opening sensor 75 is installed to project from a sensor-mounted part of the sensor cover 43 toward the bottom face of the concave portion of the gear housing 42. The EGRV opening sensor 75 is mainly constructed by the Hall IC which outputs a voltage signal (analog signal) corresponding to the density of the magnetic flux intersecting the magnetism-sensing surface of the semiconductor Hall device, to the ECU 10. Other non-contact type magnetism sensing element such as only a Hall device or a magneto-resistive element may be used instead of the Hall IC.

The ECU 10 stores information of the mechanical opener position OO in the memory of the microcomputer. The mechanical opener position OO is a valve stop position to which the EGR valve 3 is biased by the biasing force of the spring SP when the electricity supply to the motor M is stopped. At this time, the EGR valve 3 fully closes the passage 21, 22.

In addition, the mechanical opener position OO corresponds to the neutral position where the biasing force of the return spring 7 and the biasing force of the overturn spring 8 are balanced with each other, in this embodiment.

The EGRV has a valve structure in which the C-shaped seal ring 5, which has a seal function relative to the sphere-surface concave portion 66 of the nozzle 2 using the self tension in the diameter-extended direction, is combined and fitted to the seal ring groove 4 of the EGR valve 3.

Due to the extension length of the seal ring 5 generated by the tension in the diameter-extended direction and the sphere-surface concave portion 66 of the nozzle 2, the EGRV has a flow rate dead band located adjacent to the mechanical opener position OO, in which the leak amount of EGR gas (fluid flow rate, fluid leak amount, EGR amount) does not change. Specifically, the flow rate dead band is located front or behind the neutral position OO (for example, ±2.5-5.5°, ±3.0-5.0 °, or about ±3.5°.

The sphere-surface concave portion 66 is defined on the inner circumference face of the nozzle 2 over all the passage full close range (the flow rate dead band), and the slide part of the seal ring 5 can contact the sphere-surface concave portion 66. Even if the valve position of the EGR valve 3 is separated from the mechanical opener position OO, the slide part of the seal ring 5 can continue contacting to the valve seat surface of the sphere-surface concave portion 66 of the nozzle 2 until passing through the sphere-surface concave portion 66 of the nozzle 2.

The mechanical opener position OO corresponds to a valve position of the EGR valve 3 biased by the biasing force of the return spring 7 and the biasing force of the overturn spring 8 when the electricity supply to the electric motor M is stopped. That is, the mechanical opener position OO may correspond to the neutral position where the biasing force (first spring torque) of the return spring 7 and the biasing force (second spring torque) of the overturn spring 8 are balanced with each other. The full close position AA is a valve position of the EGR valve 3 which is rotated in a valve opening direction from the mechanical opener position OO.

When the EGR valve 3 is located at the full open position CC, the clearance between the inner circumference face of the nozzle 2 and the peripheral end face of the EGR valve 3 becomes the maximum. At this time, the amount of EGR gas flowing through the EGR passage 21, 22 becomes the maximum.

The ECU 10 sets the full close position AA within the passage full close (the flow rate dead band). The EGR valve 3 located at the full close position AA may have the maximum open degree in the dead band.

Operation of the EGRV will be explained with reference to FIGS. 4A to 8.

When an ignition switch of the engine is turned on (IG-ON), the ECU 10 variably controls the valve opening of the EGRV so that the EGR rate has the optimum value corresponding to an operation condition of the engine.

Specifically, the ECU 10 conducts the feedback control relative to the electric power supplied to the motor M driving the shaft 6 of the EGR valve 3 in a manner that the EGRV open degree signal output from the EGRV opening sensor 75 is in agreement with a target EGR open degree value. The target EGR open degree value is a target value (target EGR rate) set to correspond to the operation condition of the engine such as engine rotation velocity measured from the NE pulse signal of the crank sensor 72 or engine load signal of the accelerator sensor 73 or the throttle opening sensor 74.

### (i) At the Engine-Stopped Time

The ECU 10 turns off the energization of the electric motor M when the ignition switch is turned off (IG-OFF). Thus, when electric power is not supplied to the electric motor M which drives the EGR valve 3, the EGR valve 3 is biased by the first and second spring torques of the spring SP to the valve stop position (i.e., the mechanical opener position OO), as shown in FIG. 4A. Here, the mechanical opener position OO is set within the passage full close range (the flow rate dead band).

As shown in FIG. 4B, the mechanical opener position OO is set at a halfway point between a valve-closing-side critical point X of the sphere-surface concave portion 66 and a valve-opening-side critical point Y of the sphere-surface concave portion 66. When the slide part of the seal ring 5, which is fitted with the groove 4 of the EGR valve 3, tightly fits the valve seat surface of the sphere-surface concave portion 66 of the nozzle 2, which is supported by the fitting 65 of the housing 1, the EGR passage 21, 22 is closed. Thereby, EGR gas is not mixed into fresh and clean intake air passing through the air cleaner (EGR cut).

### (ii) At the Idle-Operation Time

When the ignition switch is turned on (IG-ON), the ECU 10 calculates the target value (target EGR rate, target EGR open degree) set to correspond to the operation condition of the engine. At the idle-operation time when the engine load is low and when the engine rotation velocity is low, introduction of EGR gas is stopped, to make the engine combustion stable.

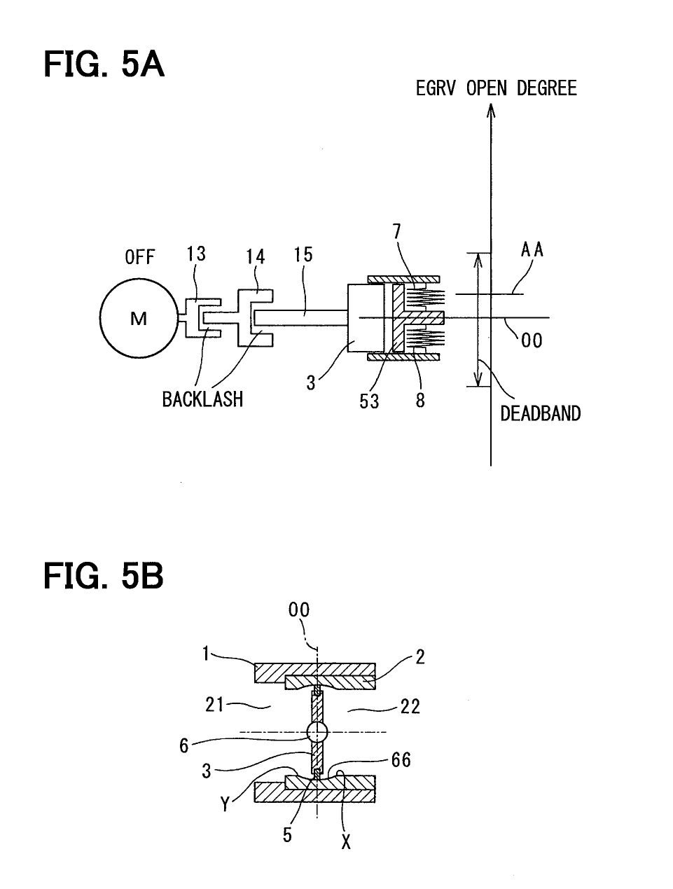

Also in this case, electricity supply to the electric motor M is stopped, thereby the EGR valve 3 is biased to the mechanical opener position OO by the biasing force of the spring SP, as shown in FIG. 5A. That is, the EGR valve 3 is biased to the neutral position at which the first spring torque and the second spring torque are balanced when the electricity supply is stopped for the electric motor M.

As shown in FIG. 5B, the EGR passage 21, 22 is closed because the slide part of the seal ring 5 tightly fits the valve seat surface of the sphere-surface concave portion 66 of the nozzle 2. Thereby, EGR gas is not mixed into fresh and clean intake air passing through the air cleaner (EGR cut).

At this time, the driving force (motor torque) of the electric motor M does not act on the gears 13, 14, 15. Therefore, as shown in FIG. 5A, the teeth face of one of the gears meshing with each other is not pressed on the teeth face of the other gear. That is, each of the gears 13, 14, 15 has freedom. Thus, the backlash of the teeth faces becomes large between two gears meshing with each other (between the pinion gear 13 and the middle gear 14, between the middle gear 14 and the output gear 15).

(iii) At the EGR Gas Introduction Time

When the accelerator is pressed so that the engine has a predetermined operating range (for example, low load to middle load and low speed rotation to middle speed rotation), the ECU 10 calculates the target value (target EGR rate, target EGR open degree) set to correspond to the operating range (engine load and engine rotation velocity).

As shown in FIGS. 6A and 6B, at the EGR gas introduction time, the ECU 10 opens the EGR valve 3 to have an open degree larger than a predetermined value. For example, the target value is set at the full open position CC. Then, electric power is supplied to the electric motor M, and the shaft 11 of the electric motor M is rotated in the valve opening direction. Thereby, the rotation power (motor torque) of the electric motor M is transmitted to the pinion gear 13, the middle gear 14, and the output gear 15. The shaft 6 receiving the motor torque from the output gear 15 is rotated by a predetermined rotation angle in the valve opening direction in accordance with the rotation of the output gear 15.

Thus, the amount of electric power supplied to the motor M is variably controlled in accordance with the operation condition of the engine, thereby changing the valve opening of the EGRV. Thus, the introduction amount (mix amount) of the EGR gas can be controlled relative to the amount of intake air passing through the air cleaner. That is, the open degree of the EGR valve 3 is controlled to correspond to the target value. That is, the EGR passage 21, 22 is opened.

Thereby, EGR gas recirculates from the exhaust passage to the intake passage via the exhaust-side part of the EGR duct P, the EGR cooler Q, the middle part of the EGR duct P, the internal passage of the housing 1 of the EGRV (EGR gas introduction port), the EGR passage 21, 22, the EGR gas discharge port, and the intake-side part of the EGR duct P. Thus, the EGR gas is mixed into the intake air supplied to the inlet port and the combustion chamber of each cylinder of the engine. Accordingly, harmful matter such as NOx contained in the exhaust gas can be reduced.

### (iv) At the High-Load and High-Rotation Time

When the accelerator is pressed so that the engine has a predetermined operating range (for example, high load and high speed rotation), the ECU 10 calculates the target value (target EGR rate, target EGR open degree) set to correspond to the operating range (engine load and engine rotation velocity).

At the high-load and high-rotation time, as shown in FIGS. 7A and 7B, the ECU 10 sets the target value at the full close position AA set at a valve position to which the EGR valve 3 is rotated in the valve opening direction from the mechanical opener position OO. In addition, the full close position AA is set within the passage full close range (the flow rate dead band).

If EGR gas, which does not contribute to the combustion, is introduced into the combustion chamber, the engine output will be lowered, while a driver of the vehicle wants to obtain the engine output at the maximum level. According to the embodiment, the EGR valve 3 is controlled to be located at the full close position AA for avoiding lowering in the engine output.

The ECU 10 continues supplying electric power to the electric motor M so that the valve position of the EGR valve 3 is located at the full close position AA. When the sensor output signal (EGRV opening signal, EGRV real opening) output from the EGRV opening sensor 75 arrives at the full close position AA, the electric power supplied to the electric motor M is maintained to a specified value. For example, very small electric current is supplied to the electric motor M to keep the position of the valve 3 in the valve opening direction. Thereby, the motor torque and the first spring torque act on the EGR valve 3, and the EGR valve 3 is held at the full close position AA.

According to the EGRV of this embodiment, as shown in FIG. 7A, the full close position AA is defined within the passage full close range (the flow rate dead band). Therefore, when the valve opening of the EGRV is held at the full close position AA, the slide part of the seal ring 5 tightly contacts the valve seat surface of the sphere-surface concave portion 66 of the nozzle 2 due to the tension of the seal ring 5 itself in the diameter-expanded direction. Thus, the slide part of the seal ring 5 sticks to the valve seat surface of the sphere-surface concave portion 66 of the nozzle 2.

Therefore, the clearance can be completely sealed between the peripheral end surface of EGR valve 3 and the valve seat surface of the sphere-surface concave portion 66 of the nozzle 2. The leak of EGR gas is certainly restricted when the EGR valve 3 is held at the full close position AA, namely, when the EGR valve 3 is fully closed, therefore the EGR gas is restricted from mixing with intake air (EGR cut).

At this time, the motor torque and the first spring torque are acting on the gears 13, 14, 15. Therefore, the teeth face of one of the gears meshing with each other is pressed on the teeth face of the other gear. That is, as shown in FIG. 7A, each gear does not have freedom. Thus, the backlash of the teeth faces becomes small or zero between two gears meshing with each other (between the pinion gear 13 and the middle gear 14, between the middle gear 14 and the output gear 15).

According to the embodiment, when the engine load is low and when the engine rotation velocity is low (idle operation time), the supply of electric power to the electric motor M which drives the shaft 6 of the EGR valve 3 is stopped, thereby holding (biasing) the EGR valve 3 at the mechanical opener position OO. That is, the EGR valve 3 can be returned to the mechanical opener position OO by the spring torque of the spring SP. Thus, the consumption power can be reduced, and the fuel mileage of the vehicle can be maintained as large.

According to the embodiment, the motor M is energized in a manner that the EGR valve 3 is held at the full close position AA that is a valve position to which the valve 3 is rotated in the valve opening direction from the mechanical opener position OO, when the engine load and the engine rotation velocity are high. Thus, the EGR valve 3 is held at the full close position AA set within the passage full close range (the flow rate dead band). At this time, the motor torque and the first spring torque act on all of the gears 13, 14, 15 which transmit the rotation power of the electric motor M to the EGR valve 3.

Therefore, the teeth face of one of the gears meshing with each other is pressed on the teeth face of the other gear. That is, the teeth face of the pinion gear 13 is pressed on the teeth face of the middle gear 14, and the teeth face of the middle gear 14 is pressed on the teeth face of the output gear 15.

Thus, the teeth faces have no backlash between two gears meshing with each other (between the pinion gear 13 and the middle gear 14, between the middle gear 14 and the output gear 15). Therefore, rattling between the gears meshing with each other can be reduced when the engine or the vehicle is vibrated, and the gears do not repeat collision or friction. Accordingly, unusual wear of the teeth face of each gear can be prevented. Moreover, the rattling sound can be reduced, therefore the noise can be restricted from being generated, compared with the following comparison example.

The comparison example will be described with reference to FIGS. 9, 10, 11A and 11B. An exhaust gas recirculation (EGR) system controls a flow rate of EGR gas using a valve 101 that is rotatably arranged in an EGR passage 104 defined in a nozzle 103 supported by a housing 102.

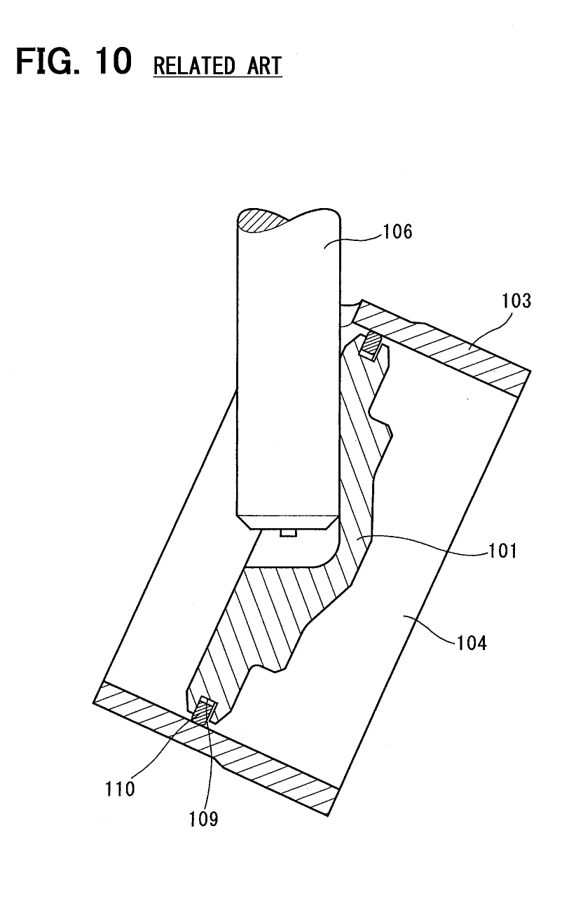

The housing 102 has a bearing hole 105 extending in a rotation axis direction of the valve 101. A first end of a shaft 106 supports the valve 101, and a second end of the shaft 106 is connected to a reduction mechanism through the bearing hole 105. A bearing portion such as bush 107 and ball bearing 108 is arranged in the hole 105. The valve 101 has a groove 109, and a seal ring 110 is fitted with the groove 109, as shown in FIG. 10.

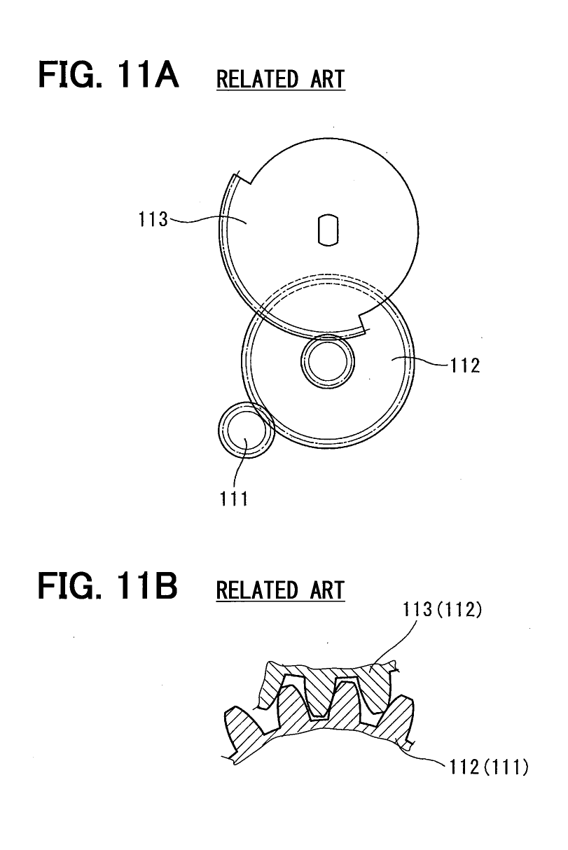

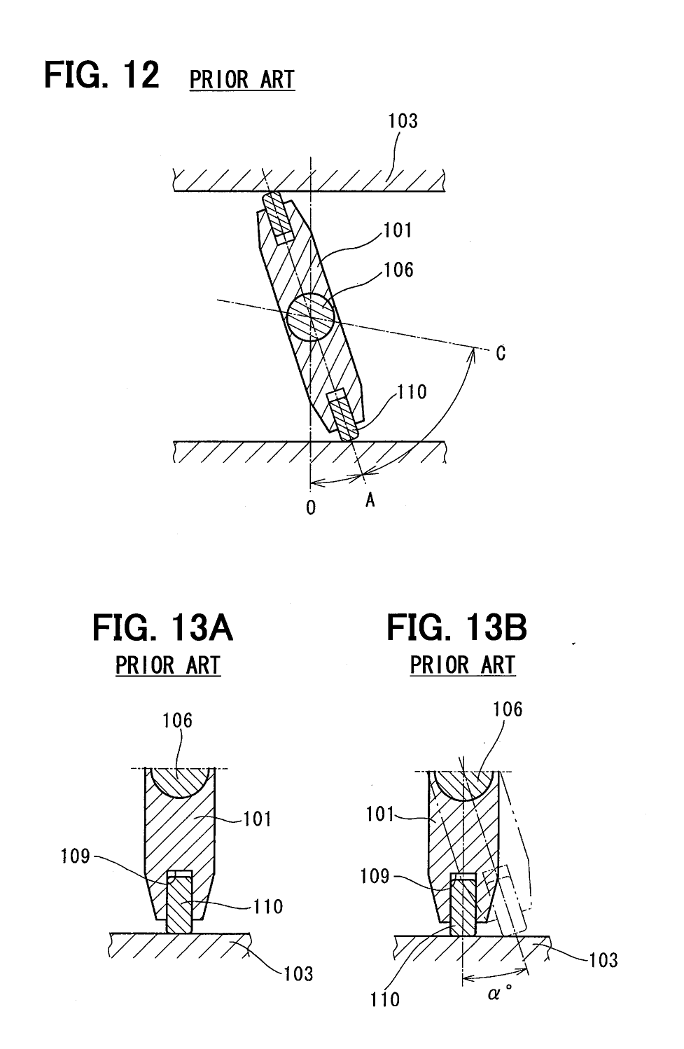

As shown in FIG. 11A, the reduction mechanism has a first gear 111, a second gear 112 and a third gear 113. A predetermined backlash is defined between teeth faces of the gears 111, 112, 113, as shown in FIG. 11B, so that the gear 111, 112, 113 works smoothly.

If the energizing of the motor is stopped, the valve 101 is returned to the full close position by the biasing force of a return spring 114. When the valve 101 is held at the full close position by the biasing force of the return spring 114, the valve 101 may rattle due to the backlash. Especially when the engine has high load or high rotation speed, the vibration of the engine or the vehicle may be transmitted to the housing 102. In this case, the gears 111, 112, 113 may have large rattling. The gears 111, 112, 113 repeat collision or friction, and the teeth face of each gear 111, 112, 113 has unusual wear.

In contrast, as shown in FIG. 7A, according to the embodiment, when the engine has high load, the gears 13, 14, 15 have no backlash with each other, therefore the gears 13, 14, 15 are restricted from having unusual wear.

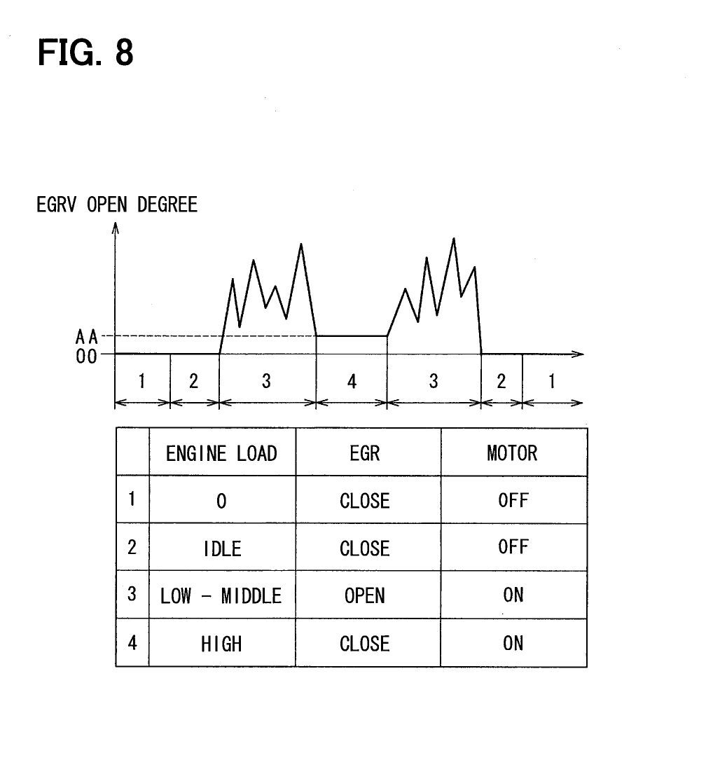

Further, as shown in FIG. 8, when the engine has low load, the energization of the motor is stopped, therefore the consumption power can be reduced.

### (Modifications)

The present disclosure is applied to the EGR control system in the above embodiment. Alternatively, the present disclosure may be applied to an intake air control system or an exhaust air control system.

The intake control valve may be a tumble control valve, a swirl control valve, an intake flow rate control valve, an intake pressure control valve, a passage switch valve, and the like.

The exhaust control valve may be a waste gate valve, a scroll switch valve, an exhaust flow rate control valve, an exhaust pressure control valve, an exhaust switch valve, and the like.

In the embodiment, the EGR valve 3 is driven by the electric actuator. Alternatively, the EGR valve 3 may be driven by a negative-pressure operation type actuator equipped with electromagnetic or electromotive negative-pressure control valve, or electromagnetic actuator such as electromagnetic fluid control valve.

In the above embodiment, the EGR valve 3 is fitted to the housing 1 through the nozzle 2. Alternatively, the EGR valve 3 may be directly fixed to inside of the housing 1. In this case, the nozzle 2 becomes unnecessary and the number of components and human labor for producing the EGRV can be reduced. In addition, the seal ring groove 4 and the seal ring 5 may be eliminated. In this case, the number of components and human labor for producing the EGRV can be reduced.

When the engine is operated with high load or high rotation velocity, the EGR valve 3 may be held at a full close position AA′ which is a valve position to which the valve 3 is rotated in the valve closing direction from the mechanical opener position OO. In this case, the motor torque of the electric motor M and the biasing force (second spring torque) of the overturn spring 8 act on the gears 13, 14, 15. Thereby, the backlash between the teeth faces of two of the gears can be eliminated, therefore unusual wear of the teeth face of each gear can be prevented similarly to the embodiment.

Such changes and modifications are to be understood as being within the scope of the present disclosure as defined by the appended claims.

What is claimed is:

1. A control device for an internal combustion engine comprising:
a fluid control valve defining a fluid passage communicating with a combustion chamber of the internal combustion engine and having a valve that opens or closes the fluid passage;
a motor driving the valve in an open direction or a close direction;
a plurality of gears transmitting a power of the motor to the valve;
a first biasing portion biasing the valve in the close direction;
a second biasing portion biasing the valve in the open direction; and
a controller variably controlling electricity power supplied to the motor based on operation condition of the internal combustion engine, wherein
the fluid control valve has a full close range in which the fluid passage is closed when the valve is operated to be fully closed,
the valve is held at a neutral position where a biasing force of the first biasing portion and a biasing force of the second biasing portion are balanced with each other when the controller stops supplying the electricity power to the motor,
the neutral position is set within the full close range, and
the controller stops supplying the electricity power to the motor when the internal combustion engine has low load and low rotation.

2. The control device according to claim 1, wherein
the valve is defined to have a full close point at a position displaced from the neutral position in the open direction,
the full close point is set within the full close range, and
the controller supplies the electricity power to the motor in a manner that the valve is held at the full close point when the engine has high load or high rotation.

3. The control device according to claim 1, wherein
the fluid control valve has a dead band in which a leak amount of fluid is constant, and
the full close range corresponds to a range of the dead band.

4. The control device according to claim 1, wherein
the fluid control valve has a housing defining the fluid passage inside, and
the valve is rotatably arranged in the fluid passage.

5. The control device according to claim 4, wherein
the fluid control valve has a seal ring sealing a clearance defined between a wall face of the fluid passage of the housing and an outer circumference face of the valve, and
the seal ring is fitted to the valve to rotate integrally with the valve.

6. The control device according to claim 5, wherein
the housing has a sphere-surface concave portion to which the seal ring slidably contacts, and
the sphere-surface concave portion is made of a part of surface of a sphere having a curvature radius centering at a center point of a rotation axis of the valve.

7. The control device according to claim 5, wherein
the valve controls a flow rate of fluid flowing through the fluid passage together with the housing and the seal ring.

8. The control device according to claim 1, wherein
the plurality of gears has a valve gear coupled with the valve to rotate integrally with the valve.

9. The control device according to claim 8, wherein
the first biasing portion is made of a first coil spring that applies a load to the valve gear or the valve in a direction returning the valve to the neutral position.

10. The control device according to claim 8, wherein
the second biasing portion is made of a second coil spring that applies a load to the valve gear or the valve in a direction returning the valve to the neutral position.

11. The control device according to claim 1, wherein
the fluid control valve is applied to an exhaust gas recirculation system that recirculates a part of gas exhausted from the internal combustion engine as EGR gas, and
the fluid control valve controls a flow rate of the EGR gas.
